(19) United States
(12) Patent Application Publication
(10) Pub. No.: US 2007/0183752 A1
(43) Pub. Date: Aug. 9, 2007

(54) Method and apparatus for generating continouous audio to a slideshow

(75) Inventor: Leonardus M.M. Veugen, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,434

(22) PCT Filed: May 23, 2005
(86) PCT No.: PCT/IB05/51676

§ 371 Date: Nov. 21, 2006

Related U.S. Application Data
(60) Provisional application No. 60/574,236, filed on May 25, 2004.

(51) Int. Cl. H04N 7/00

(52) U.S. Cl. 386/96

(57) ABSTRACT

A method and apparatus for continuous audio documents for visual presentations without interruptions are provided. An audio input (126) is used to visually describe an electronic document or image displayed upon a display device (106). The video part of the slide show is recorded, and then placeholders are used for the audio data so that audio data can be later recorded to a disc at the locations of the placeholders.

The present invention generally relates to a digital imaging device and, more particularly, to a method and apparatus for adding continuous audio to a slideshow on a recording device.

Various mechanisms are available to enable communications between people including oral, visual, and written media. For example, a DVD-recorder or other similar digital equipment is able to store a slideshow of digital pictures on a DVD disc as a video title. These images taken by a digital photo camera are inputted to the equipment by a variety of means: memory card, cable connection (e.g., USB) or a wireless connection. The process of generating the video slideshow is non-real time and highly interactive as a user needs time to select the appropriate images and transfer the image to the equipment. However, tools for creating audio to a slideshow are not designed to handle real-time process, thus it is impossible to record a continuous audio signal to the slideshow using a consumer device, such as a DVD-recorder.

Therefore, what is needed is a method and apparatus for creating a simple and effective multimedia tool that overcomes the limitations found within the prior art and provides additional advantages.

The present invention provides a method and apparatus for creating a multimedia presentation stored in a digital imaging device without audio interruptions. In one aspect of the present invention, a representation of video data in the digital imaging device and the locations of the place holders for audio packets are stored. The video data is not stored at the location of the placeholders, so that a user can interactively record audio data onto the locations of the placeholders later. These steps are repeated to provide a slideshow with continuous audio presentation for subsequent playback.

In another aspect of the present invention, audio data may be edited after incorporating the video data into a slideshow, where audio data is recorded in the placeholder filled with silent audio data.

Accordingly, the present invention provides a user to create, edit, and present multimedia presentations with continuous audio without hiccups or interruptions and without incorporating the images and video into complicated presentation software.

The foregoing and other features and advantages of the invention will be apparent from the following, more detailed description of preferred embodiments as illustrated in the accompanying drawings in which reference characters refer to the same parts throughout the various views.

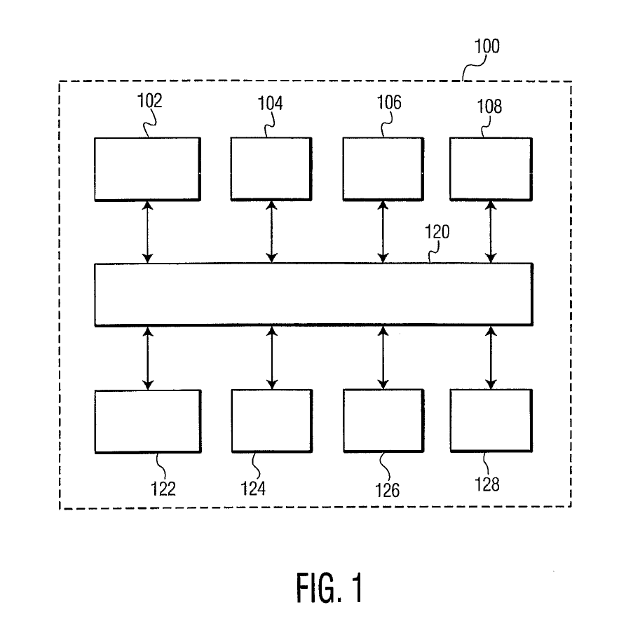

FIG. 1 is a block diagram illustrating an example of hardware components of a recording device that can be used to perform the present invention.

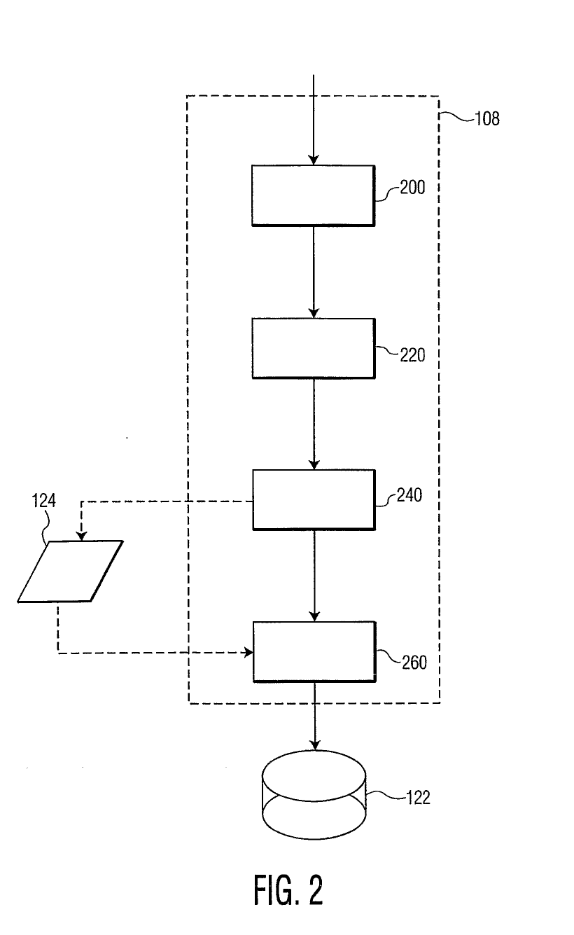

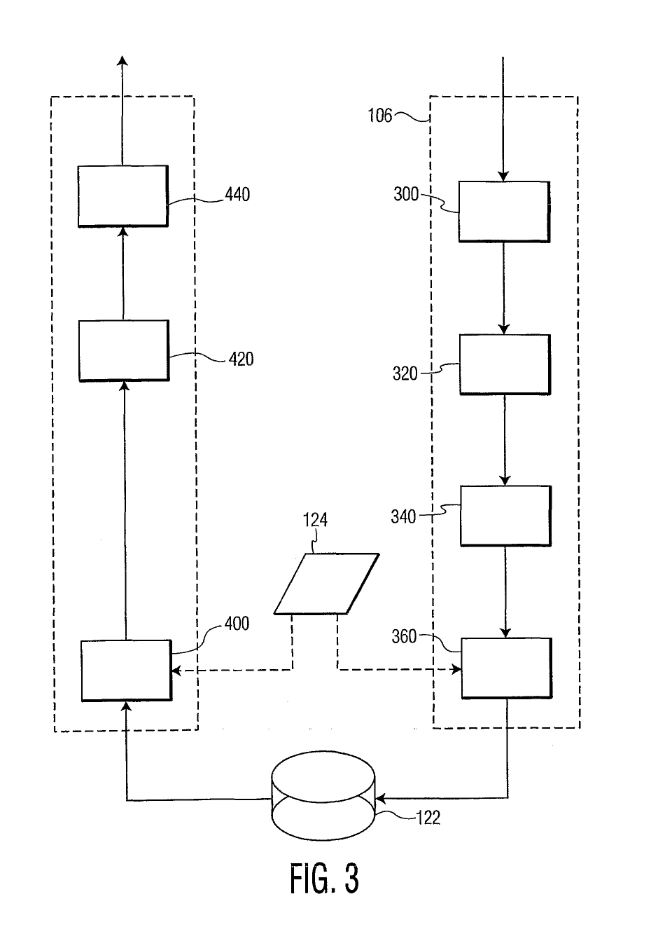

FIGS. 2 and 3 are flowcharts depicting the process of generating continuous audio in accordance with the present invention.

It is to be understood by persons of ordinary skill in the art that the following descriptions are provided for purposes of illustration and not for limitation. An artisan un derstands that there are many variations that lie within the spirit of the invention and the scope of the appended claims. Unnecessary details of known functions and operations may be omitted from the current description so as not to obscure the present invention.

Referring now to FIG. 1, a block diagram of one preferred embodiment of a recording device 100 is shown for use in accordance with the present invention. The recording device 100 is capable of capturing and displaying various types of image data including digital video and high-resolution still images. The recording device 100 includes the following: a control processor 102; an audio device 104 for playing and recording audio; a display 106 for displaying digital video and still images; a video device 108; a system bus 120 for connecting the main components of the recording device 100; a data storage device 122; a PLDB (placeholder location database) 124 for temporarily storing the locations of the placeholders for audio packets and padding packets; a remote control 126 for interaction with the user; and, a power supply 128. In an alternate embodiment, the audio device 104 and the video device 108 may be integrated as a single device to perform the equivalent functions of both devices. Note that the system bus 120 is capable of linking to a network that may include multiple processing systems. The network of processing systems may comprise a local area network (LAN), a wide area network (WAN) (e.g., the Internet), and/or any other interconnected dat a path across which multiple devices may communicate.

The processor 102 may include a conventional microprocessor device for controlling the overall operation of recording device 100. The processor 102 is capable of concurrently running multiple software routines to control the various processes of a recording device within a multithreaded environment. Also, processor 102 processes data signals and may comprise various computing architectures including a complex instruction set computer (CISC) architecture, a reduced instruction set computer (RISC) architecture, or an architecture implementing a combination of instruction sets. Although the processor 102 is preferably a microprocessor, one or more DSP (digital signal processor) or ASIC (Application Specific Integrated Circuit) could be used also.

The audio device 104 is equipped to receive audio input and transmit audio output. The audio device 104 may contain one or more analog-to-digital or digital-to-analog converters, and/or one or more digital signal processors to facilitate audio processing.

The display 106 represents any device equipped to display electronic images and data as described herein. Display device 106 may be a cathode ray tube (CRT), liquid crystal display (LCD), or any other similarly-equipped display device, screen, or monitor.

The video device 108 may include an imaging device, such as a charged coupled device (CCD) or a CMOS sensor, for capturing frames of image data in Bayer format. The image frames are transferred from the video system 108 to the processor 102 for processing, storage, and display.

The bus 120 represents a shared bus for communicating information and data, and may represent one or more buses including an industry standard architecture (ISA) bus, a peripheral component interconnect (PCI) bus, a universal serial bus (USB), or some other bus known in the art to provide similar functionality.

The data storage 122 and PLDB 124 may be a dynamic random access memory (DRAM) device, a static random access memory (SRAM) device, one or more devices including a hard disk drive, a floppy disk drive, a CD-ROM device including recordable or rewritable CDs, a DVD-RAM device, a DVD+R device, a DVD-R device, DVD+RW device, DVD-RW device, a flash memory device, or some other mass storage device known in the art. As such, recorded video and audio data, and an error correction code (ECC) in the data storage 122 may be decoded by the video device 108 under the control of the processor 102.

An input device 126 such as a remote control may be used to communicate information and command selections to processor 102. It also represents a user input device equipped to communicate positional data as well as command selections to processor 102 and may include a mouse, a trackball, a stylus, a pen, cursor direction keys, or other mechanisms to cause movement of a cursor.

The power supply 128 supplies operating power to the various components of recording device 100 and communicates with the processor 102 to coordinate power management operations for recording device 100. Note that the power supply 128 may be coupled to an external power source.

It will be apparent to one skilled in the art that recording device 100 may include more or fewer components than those shown in FIG. 1 without departing from the spirit and scope of the present invention. For example, additional components may be coupled to recording device 100 including image scanning devices, digital still or video cameras, or other devices that may or may not be equipped to capture and/or download electronic data.

Referring to FIGS. 2 and 3, generating continuous audio without interruptions according to the present invention occurs in two phases. FIG. 2 illustrates the first phase of creating the slideshow without the audio, and FIG. 3 illustrates the second phase of adding audio data to the slideshow.

As shown in FIG. 2, the process of providing the slideshow is achieved by the video components of the recording device 110. In particular, a picture insert circuit (PINS) 200 is provided to retrieve the input picture from a variety of input sources (e.g., jpeg, tiff, bmp, etc.) and converts the input picture to a uniform digital format suitable for further processing. A Video Encoder 220 serves to encode the converted input picture into an MPEG still image. Here, the result is outputted by means of 2KB (=2048 bytes) units, called packs or packets. A multiplexer (MUX) 240 then constructs the output of the encoder 220 according to the DVD E-STD Model or MPEG P-STD Model. For each VOBU, MUX 240 constructs a Navpack, video packets, and (optional) sub-picture packets. MUX 240 can be configured to multiplex audio placeholders instead of real audio packets, in which case MUX 240 fills locations of the placeholders in the PLDB 124. That is, MUX 240 multiplexes audio placeholders instead of real audio packets at the places where the real audio will be located. The WRITERI 260 writes the multiplexed packets to the data storage medium 122. Here, it is configured such that it writes all the data (video, Navpack, sub-picture, etc) to the data storage medium 122 and does not write data to the data storage 122 at the locations of the placeholders. The WRITERI 260 knows the locations of the placeholders from the PLDB 124.

In operation, the slideshow is recorded using the above-mentioned components as follows:
A) The user selects a picture data to be recorded and specifies the duration of the picture data.
B) The PINS 200 converts the picture data to a suitable uniform digital format.
C) The VENC 220 encodes the data to an MPEG still.
D) The MUX 240 stores the locations of the placeholders in the PLDB 124. Also, the MUX determines the number of VOBUs based on the duration of the picture data. Here, in order to reduce overhead, each VOBU may have the duration of 1 second, and only the last VOBU or the last 2 VOBUs can be shorter. For each VOBU, the MUX constructs the NavPack, and sub-picture packets (optionally) for presenting the remaining duration. The MUX multiplexes audio placeholders instead of real audio packets at the places where the real audio will be located in the second phase, as explained later with reference to FIG. 3. The amount of placeholders depends on the user-selected encoding quality. If needed, the MUX also inserts place holders for padding packets for aligning to full ECC-books.
E) The WRITER1 260 then writes the multiplexed data to the data storage 122 with the exception of the placeholder data. The locations of the placeholders are retrieved from the PLDB 124 by the WRITER1 260.
F) Repeat steps A-E.

It should be noted that data are often written to optical discs in units of ECC-blocks with the size of 16 sectors of 2KB. Therefore, it is impossible to write a single sector (with data of an MPEG packet) inside an ECC-block, or to skip writing a sector in an ECC-block. Thus, the whole ECC-block must be written or skipped. If there is not enough data to fill an ECC-block completely, then the ECC-block can be filled with padding packets of 2KB. Further, the number of disc sectors occupied by the audio data depends on the encoding quality chosen by the user. Typical values for compressed audio are 128 kbps (kilobits per second), 256 kbps, or 384 kbps corresponding respectively to 8, 16, 24 disc sectors (of 2KB) per second.

Once the first phase of creating the slideshow without the audio content is achieved as illustrated above, the second phase of adding audio data to the slideshow is performed, as illustrated hereinafter with reference to FIG. 3.

Audio input, including voice input, received by an audio input device (AINP) 300 of the audio device 104 is digitized. An audio encoder (AENC) 320 then encodes the audio data into compressed audio (MPEG, AC3, etc.) format or uncompressed audio (LPCM, etc.) format. Alternatively, the audio input device (AINP) 300 can also receive digital audio that need not be encoded anymore by audio encoder (AENC) 320. A MERGER 340 serving as a filter formats the encoded audio data according to the audio part of an of an MPEG Program Stream. Note that the MERGER 340 performs a similar function as a multiplexer. Here, the MERGER 340 fills in pack headers, packet headers, SCRS, PTSes, etc. However, multiplexing is not necessary as the locations on the disc for the audio data have been determined already in the first phase and stored in the PLDB 124. Finally, a WRITER2 360 writes the audio data in the storage medium 122 at the locations of the placeholders retrieved from the PLDB 124.

Meanwhile, a READER 400 reads the video part of the slideshow data crated in the first phase from the storage medium 122. Here, the READER 400 skips reading the placeholder data using the placeholder location information stored in the PLDB 124. A decoder 420 then demultiplexes the read data and decodes the video data and, if any, sub-pictures. An output device 440 outputs the video signal representative of the decoded video data and sub-picture data.

Both READER 400 and WRITER2 360 access the storage medium 122 alternatively for read and write operations. As such, when a user starts the playback of the video images and sub-pictures, the user provides an audio signal and voice input simultaneously. The recording device 100 synchronizes the presented video with the audio input and writes the audio data to a? disc for subsequent play, as shown in FIG. 3.

In an alternate embodiment using rewritable devices, the placeholder data in the first phase may be filled and written with silent audio data instead of skipping. In such an event, the second phase can be skipped so that the user can add audio at a later point by simply overwriting the silent audio data using the same or other recording equipment. Thus, only the audio data need to be overwritten, and no video re-encoding or remultiplexing are needed.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention can be adapted in ways that are equivalent without departing from its central scope. Therefore it is intended that the present invention not be limited to the particular embodiment disclosed as the best mode contemplated for carrying out the present invention, but that the present invention include all embodiments falling within the scope of the appended claims.

What is claimed is:

1. A method for generating a multimedia presentation for a playback, the method comprising the steps of:
(a) recording a stream of video packets in a memory device (122);
(b) recording audio placeholders at locations where real audio packets will be stored; and,
(c) retrieving and adding the real audio packets to appropriate locations of the audio placeholders for a subsequent playback.

2. The method of claim 1, further comprising the step of presenting the recorded video and audio packets in a synchronized manner so as to allow playback as a slideshow.

3. The method of claim 1, wherein the memory device (122) is an optical disc.

4. The method of claim 1, wherein the step (a) further includes the steps of:
selecting a picture data having a pre-specified duration to be recorded;
converting the picture data to a predetermined digital format; and, encoding the picture data.

5. The method of claim 4, wherein the number of audio placeholders depends on an encoding quality specified by a user.

6. The method of claim 1, wherein the step (b) further includes the steps of:
storing the location of the audio placeholders;
multiplexing the audio placeholders instead of real audio packets; and,
writing the multiplexed data in the memory device (122) without the audio placeholders.

7. An apparatus for generating a multimedia presentation for a playback, comprising:
means for storing a stream of video packets in a memory device (122);
means for recording audio placeholders at locations where real audio packets will be stored; and,
means for retrieving and adding the real audio packets to the locations of the audio placeholders for a subsequent playback.

8. The apparatus of claim 7, further comprising means for presenting the recorded video and audio packets in a synchronized manner so as to allow playback as a slideshow.

9. The apparatus of claim 7, wherein the memory device (122) is an optical disc.

10. The apparatus of claim 7, wherein the storing means further includes:
means for selecting picture data having a pre-specified duration to be recorded;
means for converting the picture data to a predetermined digital format; and,
means for encoding the picture data.

11. The apparatus of claim 7, wherein the recording means further includes:
means for storing the location of the audio placeholders;
means for multiplexing the audio placeholders instead of real audio packets; and,
means for writing the multiplexed data in the memory device (122) without the audio placeholders.

12. A method for generating a multimedia presentation for a playback, the method comprising the steps of:
(a) selecting picture data comprising video packets having a pre-specified duration to be recorded;
(b) encoding and recording the picture data.
(c) recording audio placeholders at locations where real audio packets will be stored;
(d) multiplexing and storing the audio placeholders instead of real audio packets; and,
(e) retrieving and adding the real audio packets to appropriate locations of the audio placeholders to allow playback as a slideshow.

13. The method of claim 12, wherein the step (b) further includes the step of converting the picture data to a predetermined digital format.

14. A digital recording device for generating a continuous audio playback during a presentation of a slideshow, comprising:
a video device (108) for encoding and decoding the video associated with the slideshow;
an audio device (104) for recording the continuous audio;
a storage device (122) for storing video packets and audio packets for a subsequent playback;
a processor (102) coupled to the storage device (122), the video device (108), and audio device (104) for controlling operation of the digital recording device, the processor (102) functioning in a first phase such that in response to a user input, the video packets and audio placeholders where the audio packets will be stored in a second phase are recorded, the processor (102) further functioning in the second phase such that the locations of the audio placeholders are retrieved to add the audio data to appropriate locations to enable the presentation of the slideshow.

15. The digital recording device of claim 14, further comprising a display device (106) for presenting the slideshow.

16. The digital recording device of claim 14, further comprising an input device (126).

17. The digital recording device of claim 14, wherein the storage device (122) is an optical disc.
